(19) United States
(12) Patent Application Publication
(10) Pub. No.: US 2008/0154573 A1
(43) Pub. Date: Jun. 26, 2008

(54) SIMULATING NEW INPUT DEVICES USING OLD INPUT DEVICES

(75) Inventors: Robert J. Jarrett, Snohomish, WA (US); Sumit Mehrotra, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/537,808

(22) Filed: Oct. 2, 2006

(51) Int. Cl. G06F 9/455

(52) U.S. Cl. 703/23

(57) ABSTRACT

First input device data is captured from a first input device coupled to a computing device. At least a portion the first input device data is mapped to an action of a second input device, wherein the second input device is not coupled to the computing device. Second input device data associated with the second input device is generated based at least in part on the first input device data.

### BACKGROUND

Often with new input devices, there is little or no actual platform support for such an input device when it is first introduced. Hence, developing and testing software for such a platform becomes extremely difficult. For example, developers may desire to test a 64-bit tablet operating system (OS) for use with a digital pen on a 64-bit tablet personal computer (PC). However, 64-bit tablet PCs are currently not available. This situation hinders the software developer community from developing and releasing applications for 64-bit tablet PCs in a timely manner.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Embodiments herein simulate a new input device using one or more old input devices. Input data from an old input device are morphed into the input data of a new input device. In one example, a mouse and a keyboard may be used to simulate a digital pen and tablet PC buttons. The new input device data may be provided to a simulation system for injection into an operating system device stack.

Many of the attendant features will be more readily appreciated as the same becomes better understood by reference to the following detailed description considered in connection with the accompanying drawings.

### BRIEF DESCRIPTION OF THE DRAWINGS

Like reference numerals are used to designate like parts in the accompanying drawings.

FIG. 1 is a block diagram of an example computing device for implementing embodiments of the invention.

FIG. 2 is a block diagram of a morphing architecture in accordance with an embodiment of the invention.

FIG. 3 is a flowchart showing the logic and operations of simulating an input device in accordance with an embodiment of the invention.

FIG. 4 is a block diagram of a morphing architecture in accordance with an embodiment of the invention.

FIG. 5 is a block diagram of a tablet PC in accordance with an embodiment of the invention.

FIG. 6 is a block diagram of a morphing architecture in accordance with an embodiment of the invention.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples.

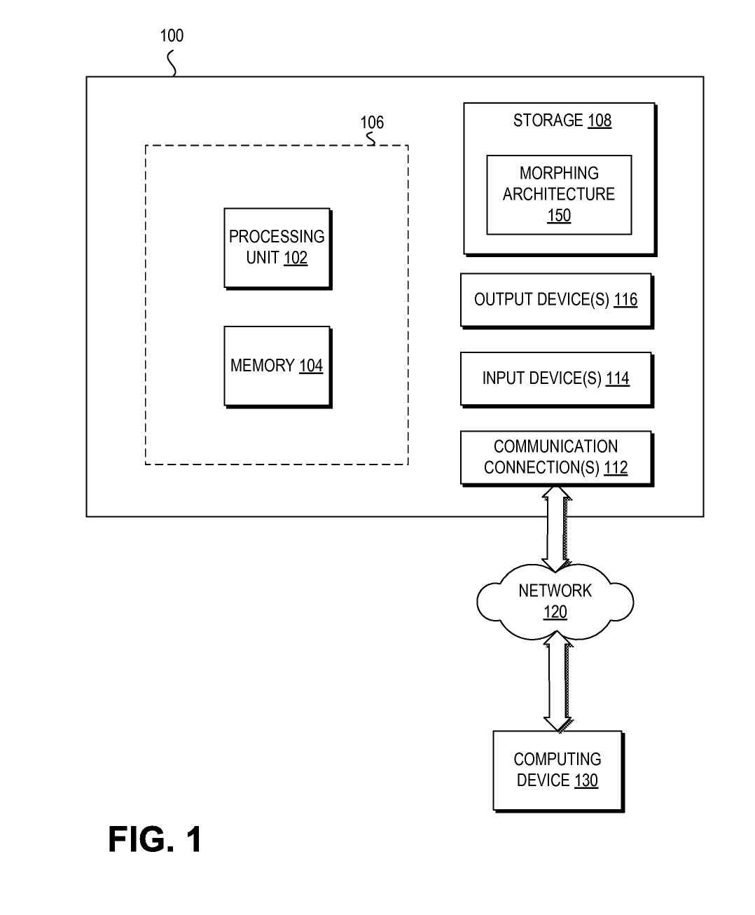

FIG. 1 and the following discussion are intended to provide a brief, general description of a suitable computing environment to implement embodiments of the invention. The operating environment of FIG. 1 is only one example of a suitable operating environment and is not intended to suggest any limitation as to the scope of use or functionality of the operating environment. Other well known computing systems, environments, and/or configurations that may be suitable for use with embodiments described herein including, but not limited to, personal computers, server computers, hand-held or laptop devices, multiprocessor systems, micro-processor based systems, programmable consumer electronics, network personal computers, mini computers, mainframe computers, distributed computing environments that include any of the above systems or devices, and the like.

Although not required, embodiments of the invention will be described in the general context of “computer readable instructions” being executed by one or more computing devices. Computer readable instructions may be distributed via computer readable media (discussed below). Computer readable instructions may be implemented as program modules, such as functions, objects, application programming interfaces (APIs), data structures, and the like, that perform particular tasks or implement particular abstract data types. Typically, the functionality of the computer readable instructions may be combined or distributed as desired in various environments.

FIG. 1 shows an example of a computing device 100 for implementing one or more embodiments of the invention. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features and/or functionality. For example, device 100 may also include additional storage (e.g., removable and/or non-removable) including, but not limited to, magnetic or optical disks or tape. Such additional storage is illustrated in FIG. 1 by storage 108. In one embodiment, computer readable instructions to implement embodiments of the invention may be in storage 108, such as morphing architecture 150. Storage 108 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions, data structures, program modules, or other data. Memory 104 and storage 108 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which can be used to store the desired information and which can be accessed by device 100. Any such computer storage media may be part of device 100.

The term “computer readable media” may include communication media. Device 100 may also include communication connection(s) 112 that allow the device 100 to communicate with other devices, such as with other computing devices through network 120. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

Device 100 may also have input device(s) 114 such as keyboard, mouse, pen, voice input device, touch input device, laser range finder, infra-red cameras, video input devices, and/or any other input device. Output device(s) 116 such as one or more displays, speakers, printers, and/or any other output device may also be included. Input devices 114 and output devices 116 may be coupled to the computing device 100 via a wired connection, wireless connection, or any combination thereof. In the following description and claims, the term “coupled” and its derivatives may be used. “Coupled” may mean that two or more elements are in contact (physically, electrically, magnetically, optically, etc.). “Coupled” may also mean two or more elements are not in contact with each other, but still cooperate or interact with each other.

Those skilled in the art will realize that storage devices utilized to store computer readable instructions may be distributed across a network. For example, a computing device 1 30 accessible via network 120 may store computer readable instructions to implement one or more embodiments of the invention. Computing device 100 may access computing device 130 and download a part or all of the computer readable instructions for execution. Alternatively, computing device 100 may download pieces of the computer readable instructions, as needed, or some instructions may be executed at computing device 100 and some at computing device 130. Those skilled in the art will also realize that all or a portion of the computer readable instructions may be carried out by a dedicated circuit, such as a Digital Signal Processor (DSP), programmable logic array, and the like.

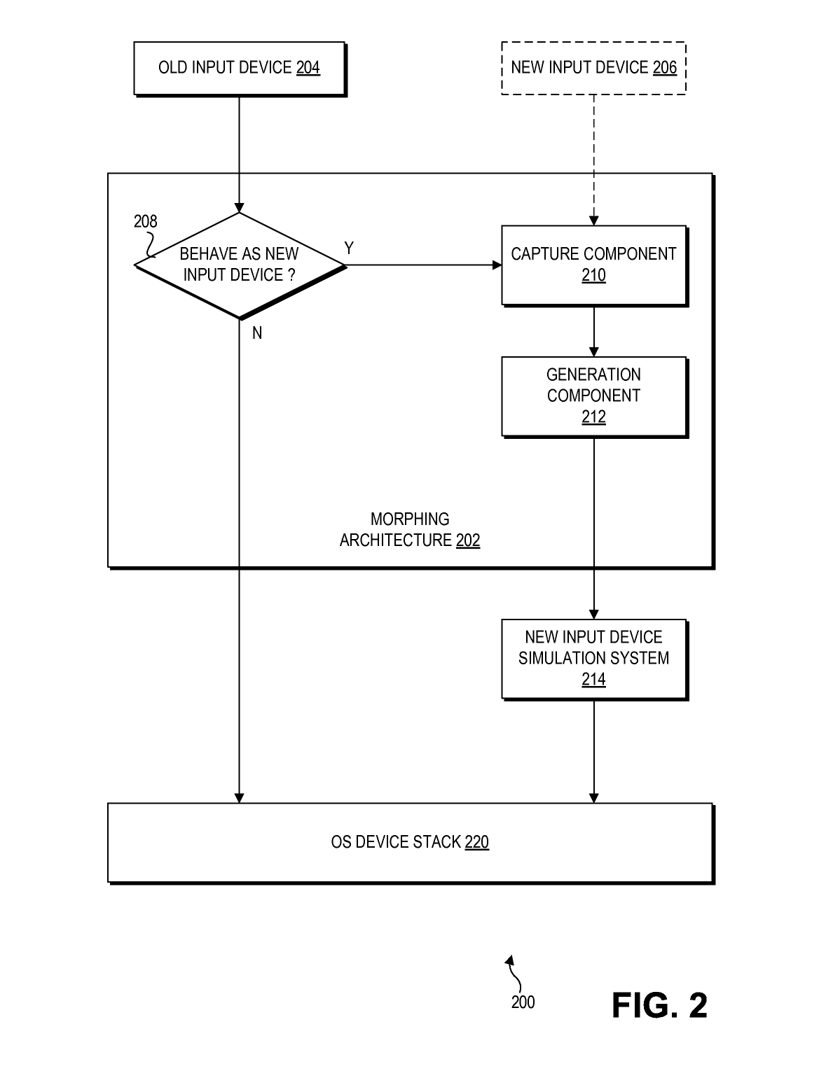

Turning to FIG. 2, a block diagram of a morphing architecture 202 in accordance with an embodiment of the invention is shown. Morphing architecture 202 is implemented on a computing device 200. Computing device 200 also includes an old input device 204, a new input device simulation system 214, and an operating system having and operating system device stack 220.

Morphing architecture 202 captures old input device data and morphs the input data into new input device data. Morphing architecture 202 may then hand the new input device data to new input device simulation system 21 4 for injection into the OS device stack 220. It will be appreciated that morphing architecture 202 is a pluggable component. Morphing architecture 202 may be used with any new input device simulation system.

In one embodiment, morphing architecture 202 is an application executing on computing device 200. Morphing architecture 202 captures the old input device data as it is received from old input device 204. However, no other applications act on the old device input data because morphing architecture eats up the old device input data (discussed further below). The old input device data is then morphed into new input device data and injected into OS device stack 220 using new input device simulation system 214. Other applications and/or the OS may then act on the new input device data.

In the case where the old input device data is not to be morphed, then the old input device data is not “eaten” but allowed to enter OS device stack 220 and eventually reach any interested consumers, such as a user application.

Morphing architecture 202 receives input data from an old input device 204. Logic of the morphing architecture (shown at 208) determines if the input data is to be treated as old input device data and injected as is into OS device stack 220 or if the input data is to be morphed into new input device data before being injected into OS device stack 220. New input device 206 is shown with a dotted line since new input device 206 is not actually attached to the computing device or new input device 206 may not even exist yet. Old input device 204 includes any input device actually coupled to computing device 200.

Morphing architecture 202 includes a capture component 210 and a generation component 212. Capture component 210 is used to capture, in real-time, data coming from usage of old input device 204. Capture component 210 may map the data captured from old input device 204 to the corresponding data elements of new input device 206.

Generation component 212 receives the old input device data from capture component 210 and generates input data for new input device 206. At least a portion of the input data for new input device 206 is based on the input data from old input device 204. In some embodiments, generation component 212 may generate input data for new input device 206 that have no corresponding elements in old input device 204.

Morphing architecture 202 provides the new input device data to new input device simulation system 214 for injection into OS device stack 220. OS device stack 220 may then act on the data as if it came from new input device 206.

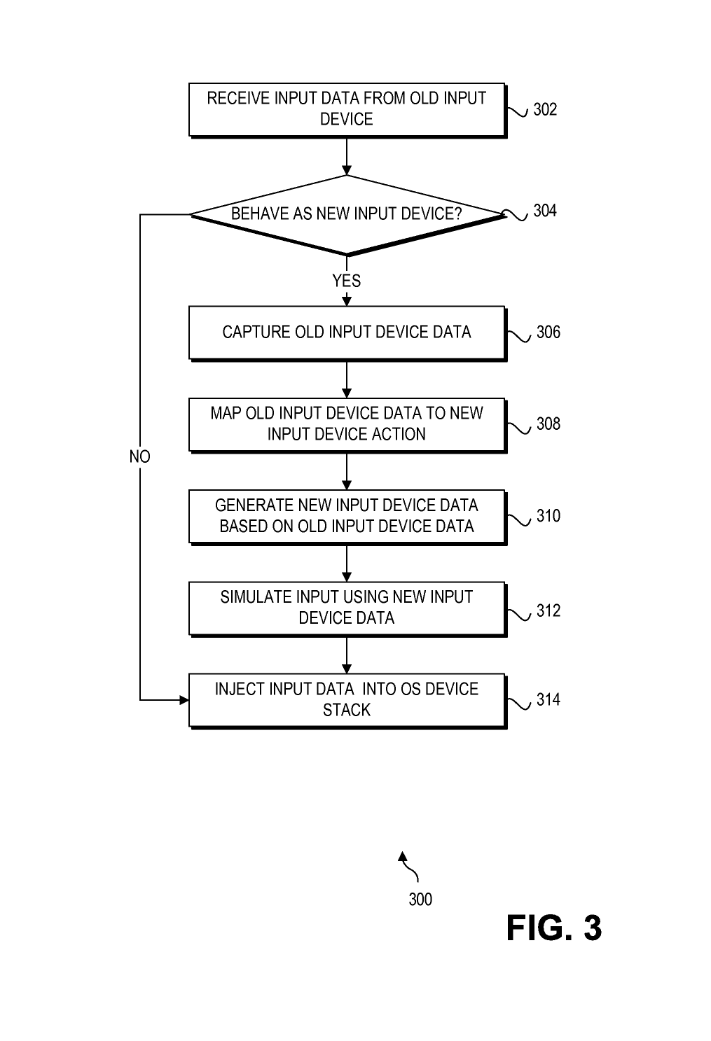

Turning to FIG. 3, a flowchart 300 shows the logic and operations of an embodiment of the invention. Starting in block 302, the morphing architecture receives input data from an old input device. Proceeding to decision block 304, the logic determines if the input data should be morphed to act as a new input device. If the answer is no, then the logic proceeds to block 314 to inject the old input device data into the OS device stack. If the answer to decision block 304 is yes, then the logic continues to block 306 to capture the old input device data.

In one embodiment, an input from old input device 204 is used to signal the morphing architecture to toggle between old input device 204 and new input device 206. For example, when a keyboard/mouse is used as old input devices, a particular key, such as F1, may be used to toggle between keyboard/mouse and simulation of a new input device. In another example, an icon in a user interface allows the user to toggle between the mouse as simulating a new input device or as a conventional mouse.

In block 306, the old input device data is captured. In one embodiment, capture component 210 eats the input data from old input device 204 when capturing the input data so that other components listening for old input device data do not “hear” the old input device data. In one example, a chain of consumers may be listening for input data from the old input device. Traditionally, a consumer reads the data before passing the input data on to another consumer in the chain. Capture component 210 may inject itself at the beginning of the chain. When capture component 210 eats the old device input data, other consumers down the chain do not see the input data from the old input device and thus not realize activity occurred at the old input device.

Continuing to block 308, the old input device data is mapped to an action by the new input device. For example, when simulating a digital pen with a mouse and a keyboard, a left click received from the mouse maps to a pen tip down action by the digital pen.

Continuing to block 310, new input device data is generated based at least in part on the old input device data. In one embodiment, generation component 212 may include a set of APIs for generating the new input device data. In another embodiment, a new input device data element may be generated that does not have a corresponding old input device data element. For example, embodiments of the invention may be used to simulate a digital pen using a mouse and keyboard. However, input from the digital pen may include data elements such as pen pressure. Since the mouse or keyboard do not have a corresponding pressure element, a pen pressure data element is created in order to complete the input data from the digital pen.

Continuing block 312, the new input device data is used to simulate an input from the new input device. In the embodiment of FIG. 2, the new input device data is provided to new input device simulation system 214. An embodiment of a new input device simulation system is described in U.S. patent application Ser. No. 10/778,346, titled “PEN DATA CAPTURE AND INJECTION,” filed Feb. 17, 2004.

Continuing to block 314, the new input device data is injected into the OS device stack by the new input device simulation system. In one embodiment, the new device input data is injected into the bottom layer of OS device stack 220. The input data enters the stack at the same level and with the same properties as if the input data was coming from a real hardware device. From that point onwards, the input data is treated as the new input device data and travels up the stack. In an example of simulating a digital pen, the digital pen data travels up a tablet personal computer (PC) software stack (also referred to as an inking stack) to be converted into ink, strokes, gestures, words, etc.

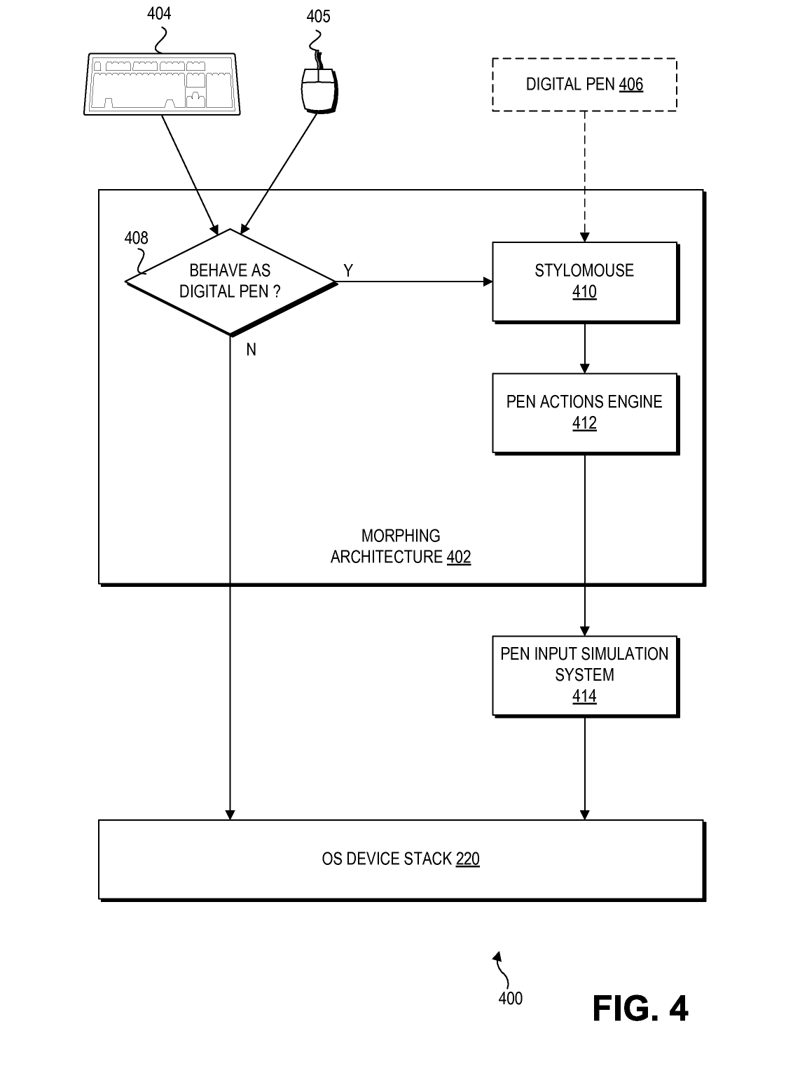

Turning to FIG. 4, an embodiment of a morphing architecture 402 on a computing device 400 is shown. Morphing architecture 402 morphs mouse 405 and/or keyboard 404 (i.e., old input devices) input data into input data for simulating a digital pen 406 (i.e., new input device).

A tablet PC may use a digital pen as an input device and ink as a native data type in an operating system platform. A digital pen has specific input properties. Such properties of a digital pen include pen location, pen pressure, pen tilt, and pen button state. A tablet PC may use these pen properties to provide pen gestures, pen feedback, digital ink, handwriting recognition, and the like.

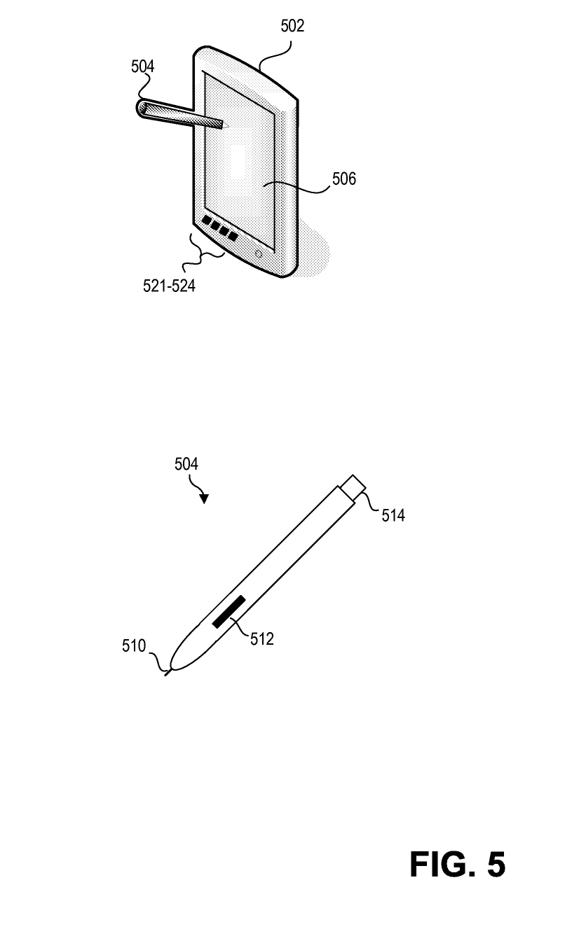

Turning to FIG. 5, an embodiment of a tablet PC 502 and associated digital pen 504 (also referred to as a stylus) is shown. Tablet PC 502 includes a screen 506 designed to interact with digital pen 504. Tablet PC 502 may include a slate model tablet PC (as shown in FIG. 5) that may not have permanent keyboard. A conventional keyboard may be attached or tablet PC 502 placed in a docking station for use with a keyboard, mouse, and video monitor.

Embodiments of tablet PC 502 may include a convertible model tablet PC that has an attached keyboard and may appear as a conventional notebook computer. However, the screen may be rotated and folded down to lie flat over the keyboard. Embodiments of tablet PC 502 may also include a personal digital assistant, a mobile phone, or other computing devices that include a screen that may be interacted with using a digital pen.

Digital pen 504 may include a pen tip 510, a pen barrel button 512, and a digital eraser 514. Pen barrel button 512 may have pre-defined functionality and/or user-defined functionality. A single pen barrel button 512 is shown for clarity but alternative embodiments may include additional pen buttons.

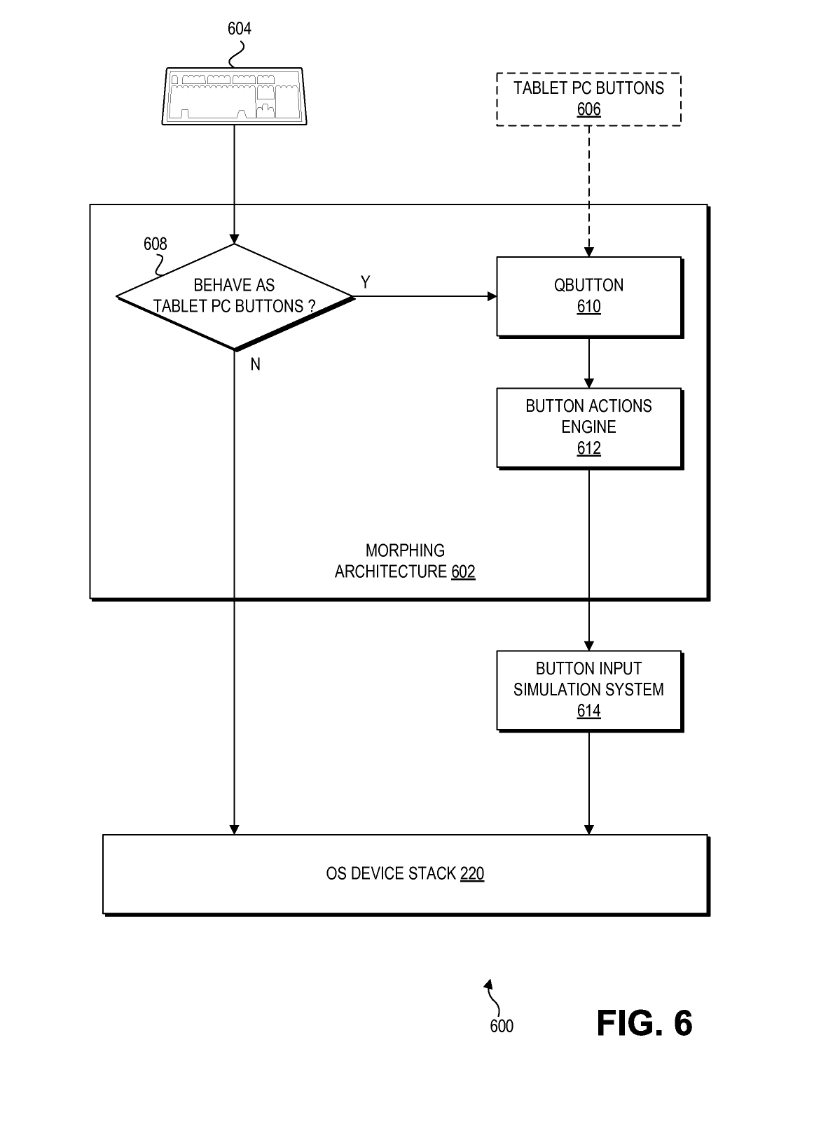

Tablet PC 502 may include tablet PC buttons, such as buttons 521-524. In one embodiment, tablet PC buttons 521-524 are hardware buttons that may have pre-defined functionality and/or user-defined functionality. While tablet PC 502 shows four tablet PC buttons, alternative embodiments may include more or less than four buttons. Embodiments of morphing keyboard inputs into tablet PC button inputs are discussed below in conjunction with FIG. 6.

Referring again to FIG. 4, morphing architecture 402 includes stylomouse 410 as the capture component and pen actions engine 412 as the generation component. Stylomouse 410 captures real-time inputs from keyboard 404 and mouse 405. Inputs from keyboard 404 and mouse 405 may be used separately or in combination to work as a digital pen.

Morphing architecture 402 receives input data from keyboard 404 and/or mouse 405. Logic 408 of morphing architecture 402 determines if the input data is to behave as a digital pen. If the answer is no, then the input data is injected into OS device stack 220 has old input device data. If the answer is yes, then the old input device data is captured by stylomouse 410.

Stylomouse 410 maps the keyboard and/or mouse input data to a pen action. A pen action may include a stroke or a gesture. When the pen actions are injected into OS device stack 220, a recognizer component interprets the pen action as a stroke or a gesture.

In one embodiment, stylomouse 410 may map the mouse and/or keyboard inputs to properties of a stroke. A stroke may be made on the tablet PC using the digital pen. In one embodiment, a stroke is defined as the set of data associated in a single pen-down, pen-move, and pen-up sequence. The stroke data includes a collection of packets. A packet is the set of data the digitizer beneath the tablet PC screen detects at each sample point. Stroke properties may also include information such as pen location, pen pressure, pen angle, and the like.

In one embodiment, stylomouse 410 may map mouse and/or keyboard inputs to pen gestures than may be performed with a digital pen. A gesture is a pen movement or a combination of movements that are assigned special behavior within an application or OS in order to implement the behavior assigned to the gesture. Such pen gestures may include a tap, a double tap, a press and hold, a flick, and the like.

Embodiments of mappings between mouse/keyboard and a digital pen are shown in Table 1 below.

TABLE 1

| MOUSE/KEYBOARD | DIGITAL PEN |
|---|---|
| Mouse Left Button Down | Pen Tip Down |
| Mouse Left Button Up | Pen Tip Lift |
| Mouse Right Button Down | Pen Barrel Button Down |
| Mouse Right Button Up | Pen Barrel Button Release |
| Mouse Move | Pen Tip Move |
| Mouse Drag | Pen Tip Drag |
| Mouse Inactive | Pen Hover |
| Mouse Position + Keyboard | Pen Flick |
| Numerical Pad Key | |
| Various keyboard keys | Other pen gestures (e.g., pen tap, pen |
| | double tap, pen press and hold, etc.) |

As shown in Table 1, a pen flick may be created using a combination of keyboard 404 and mouse 405. For example, the location of the cursor using mouse 405 defines the start point of the flick. A key from a number keypad on keyboard 404 defines the flick direction. For example, key “8” defines a flick up while key “6” defines a flick to the rig ht.

Pen actions engine 412 generates pen actions that may be used by pen input simulation system 414. These pen actions may be generated based at least in part on a type of digital pen (defined by pen properties) along with a stroke (defined by stroke properties). Pen actions may also include pen gestures.

Embodiments of pen actions engine 412 may describe properties of a particular type of digital pen. Pen properties may include physical pen dimensions, such as the physical height and width of the digital pen, and logical pen dimensions, such as the logical height and width of the digital pen in logical units used by the OS, such as pixels.

Pen properties may include the kinds of input data supported by the pen. Such input data may include positioning method (e.g., Cartesian or Polar). Other exemplary inputs include the range of pen pressure supported by the pen and the range of pen tilts supported by the pen.

Pen actions engine 412 may generate stroke properties. Such stroke properties may include stroke start point, stroke start time, stroke end point, and stroke end time. Stroke properties may include the interpoint/packet timing which describes the time between successive points that make up the stroke.

In one embodiment, stroke points, such as the start and end points, may be described using a Cartesian co-ordinate system defined by x-y positions. In another embodiment, the stroke points may be described using a Polar co-ordinate system that may be defined by (r, ⊖), where r is the radial distance from a reference origin and ⊖ is the angle in a counterclockwise direction of the point from the x-axis.

A stroke may have other properties depending on the properties supported by the writing surface on the tablet PC. A pen pressure property includes the starting pressure for the stroke and the pressure gradient of the stroke. A pen tilt property includes the starting pen tilt and the pen tilt changes during the stroke, as measured on each of the axes. A speed property describes the speed of the stroke. Stroke properties may also include the state of buttons on the digital pen. For example, the state of pen barrel button 512 may include pressed or un-pressed during the stroke.

In one embodiment, pen actions engine 412 may generate stroke properties that do not have corresponding input data from mouse 405 or keyboard 404. For example, pen pressure may not necessarily be inputted from a mouse movement. Pen actions engine 412 may generate the pen pressure property so that a pen pressure property may be provided to pen input simulation system 414. In one embodiment, the pen pressure property is provided by a programmable setting of pen actions engine 412. Other such generated stroke properties may include pen tilt and pen speed.

A stroke may include other properties that may be generated by pen actions engine 412 to describe a stroke. These additional properties may be used to describe a complex stroke such as a curved stroke and a composite stroke. A composite stroke is a stroke made up of more than one stroke in succession.

Turning to FIG. 6, an embodiment of a morphing architecture 602 is shown. Morphing architecture 602 morphs inputs from keyboard 604 (i.e., old input device) into inputs from a tablet PC button 606 (i.e., new input device). User defined keys on keyboard 604 may be mapped to behave as tablet PC buttons 606.

In FIG. 6, morphing architecture receives input data from keyboard 604. Logic 608 of morphing architecture 602 determines if the key press is to behave as a tablet PC button. If the answer is no, then the key press is injected into OS device stack 220 has a normal key press. If the answer is yes, then the key press is captured by Qbutton 610.

Qbutton 610 captures real-time data from keyboard 604. Qbutton maps a key press at keyboard 604 to the properties of a tablet PC button. For example, the key “A” on keyboard 604 may be mapped to a particular tablet PC button, such as button 521 of tablet PC 502. Key combinations may also be mapped to a tablet PC button. For example, a Ctrl-A combination may map to a tablet PC button.

Qbutton 610 passes the button mapping to a button actions engine 612. Button actions engine 612 generates the properties associated with the button press of the corresponding tablet PC button. The tablet PC button data is then passed to button input simulation system 614 which in turn injects the tablet PC button data into OS device stack 220.

Using embodiments herein, software developers may test and market software for new hardware even though the new hardware is not yet available. Often times, new hardware develops at a slower rate than software to utilize the hardware. For example, 64-bit tablet PCs may not be available, yet software developers want to test their software on a 64-bit tablet PC using digital pen inputs. In another example, a tablet PC OS may support up to 32 tablet PC buttons, however, a tablet PC may not exist that has 32 buttons. Embodiments herein allow software developers to test software on a desktop computer and simulate the behavior of tablet input devices such as digital pens and tablet PC buttons using old input devices such as a mouse and a keyboard.

Various operations of embodiments of the present invention are described herein. In one embodiment, one or more of the operations described may constitute computer readable instructions stored on computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of embodiments of the invention, including what is described in the Abstract, is not intended to be exhaustive or to limit the embodiments to the precise forms disclosed. While specific embodiments and examples of the invention are described herein for illustrative purposes, various equivalent modifications are possible, as those skilled in the relevant art will recognize in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A method, comprising:
capturing first input device data from a first input device coupled to a computing device;
mapping at least a portion of the first input device data to an action of a second input device, wherein the second input device is not coupled to the computing device; and
generating second input device data associated with the second input device based at least in part on the first input device data

2. The method of claim 1, further comprising providing the second input device data to a second input device simulation system.

3. The method of claim 2, further comprising injecting the second input device data into an operating system device stack by the second input device simulation system.

4. The method of claim 1 wherein capturing the first input device data includes eating the first input device data.

5. The method of claim 1 wherein generating the second input device data includes generating portions of the second input device data without using any part of the first input device data.

6. The method of claim 1, further comprising:
capturing third input device data from a third input device coupled to the computing device; and
generating second input device data associated with the second input device based at least in part on a combination of the first input device data and the third input device data.

7. The method of claim 6 wherein the first input device includes a mouse, the second input device includes a digital pen, and the third input device includes a keyboard.

8. One or more computer readable media including computer readable instructions that, when executed, perform the method of claim 1.

9. One or more computer readable media including computer-executable components, comprising:
a capture component to capture at least one of mouse input data and keyboard input data; and
a generation component to generate digital pen data based at least in part on the mouse input data and the keyboard input data.

10. The one or more computer readable media of claim 9 wherein the capture component to map the mouse input data and the keyboard input data to an action of a digital pen associated with the digital pen data.

11. The one or more computer readable media of claim 9 wherein the digital pen data includes one or more stroke properties.

12. The one or more computer readable media of claim 9 wherein the generation component to generate digital pen data elements that have no corresponding data elements in the mouse input data or the keyboard input data.

13. The one or more computer readable media of claim 12 wherein the digital pen elements that have no corresponding data elements includes at least one of digital pen pressure, digital pen tilt, and digital pen speed.

14. The one or more computer readable media of claim 9 wherein the digital pen data includes pen gesture properties.

15. The one or more computer readable media of claim 9 wherein the capture component to map the keyboard input data to tablet personal computer button action, wherein the generation component to generate tablet personal computer button properties based at least in part on the keyboard input data.

16. A system, comprising:
a keyboard;
a mouse; and
a computing device coupled to the keyboard and the mouse, wherein the computing device having stored computer readable instructions that, when executed by the computing device, perform operations comprising:
capturing at least one of keyboard input data from the keyboard and mouse input data from the mouse;
mapping at least a portion the keyboard input data and the mouse input data to an action of a digital pen, wherein the digital pen is not coupled to the computing device; and
generating digital pen data associated with the digital pen based at least in part on the portion of the keyboard input data and the mouse input data.

17. The system of claim 16 wherein the digital pen data includes one or more stroke properties.

18. The system of claim 1 7 wherein the one or more stroke properties include at least one of digital pen pressure, digital pen tilt, and digital pen speed.

19. The system of claim 16 wherein the digital pen data includes pen gesture properties.

20. The system of claim 16 wherein the computer readable instructions, when executed by the computing device, further perform operations comprising:
mapping the keyboard input data to a tablet personal computer button action associated with a tablet personal computer button, wherein the tablet personal computer button is not coupled to the computing device; and
generating tablet personal computer button properties based at least in part on the keyboard input data.
